(19) United States
(12) Patent Application Publication
(10) Pub. No.: US 2022/0394969 A1
(43) Pub. Date: Dec. 15, 2022

(54) Fishing Rod Holder Assembly

(71) Applicants: Andy Davila, Aransas Pass, TX (US); Trinidad Davila, Aransas Pass, TX (US)

(72) Inventors: Andy Davila, Aransas Pass, TX (US); Trinidad Davila, Aransas Pass, TX (US)

(21) Appl. No.: 17/348,463

(22) Filed: Jun. 15, 2021

(51) Int. Cl. A01K 97/10

(52) U.S. Cl. CPC A01K 97/10

(57) ABSTRACT

A fishing rod holder assembly for holding fishing rods includes a spike that has a striking surface extending laterally away from the spike for driving the spike into a support surface. A pole extends upwardly from the spike such that the pole is vertically oriented when the spike is driven into the support surface. A four way tee is removably attachable to the pole and the four way tee has a plurality of openings each being distributed around a center point of the four way tee. Moreover, a respective one of the openings insertably receives the pole. A pair of rod holders is each attachable to the four way tee when the four way tee is coupled to the pole to hold a fishing rod.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to rod holder devices and more particularly pertains to a new rod holder device for holding fishing rods. The device includes a spike which includes a lateral striking surface for driving the spike into the ground. A pole is attached to the spike and a pair of rod holders is attached to the pole. Each of the rod holders can hold a fishing rod during fishing.

### (2) Description of Related Art Including Information Disclosed Under 37 CFR 1.97 and 1.98

The prior art relates to rod holder devices including a variety of rod holder devices that include a spike and a plurality of looped members that each defines a rod holder for holding a fishing rod. The prior art discloses rod holder device that includes a triangular frame which is attachable to a chair and a plurality of rod holders attached to the triangular from for holding fishing rods. The prior art discloses a rod holder which includes a clamp that is attachable to a support and a pair of sleeves that are disposed on the clamp for holding fishing rods.

### BRIEF SUMMARY OF THE INVENTION

An embodiment of the disclosure meets the needs presented above by generally comprising a spike that has a striking surface extending laterally away from the spike for driving the spike into a support surface. A pole extends upwardly from the spike such that the pole is vertically oriented when the spike is driven into the support surface. A four way tee is removably attachable to the pole and the four way tee has a plurality of openings each being distributed around a center point of the four way tee. Moreover, a respective one of the openings insertably receives the pole. A pair of rod holders is each attachable to the four way tee when the four way tee is coupled to the pole to hold a fishing rod.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fishing rod holder assembly according to an embodiment of the disclosure.

FIG. 2 is an exploded perspective view of an embodiment of the disclosure.

FIG. 3 is a back view of an embodiment of the disclosure.

FIG. 4 is a right side phantom view of an embodiment of the disclosure.

FIG. 5 is a perspective in-use view of an embodiment of the disclosure.

### DETAILED DESCRIPTION OF THE INVENTION

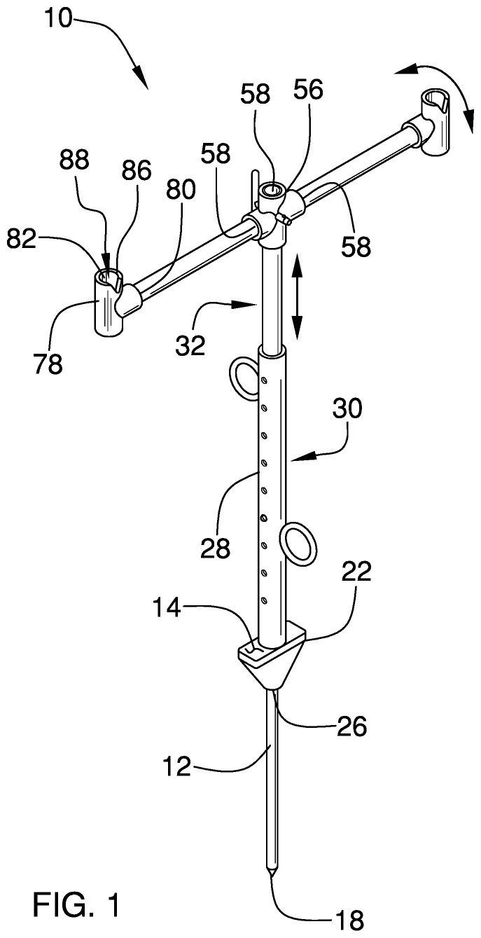

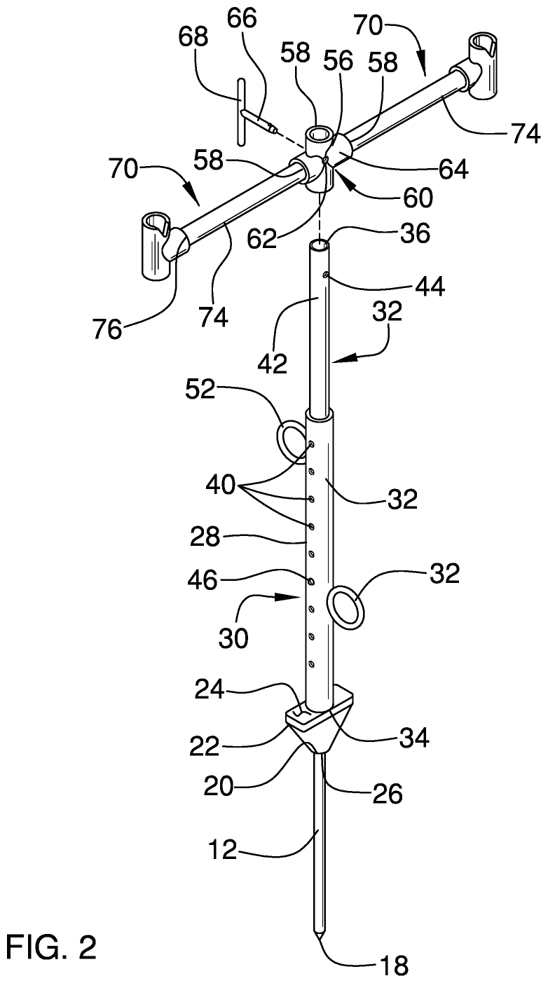

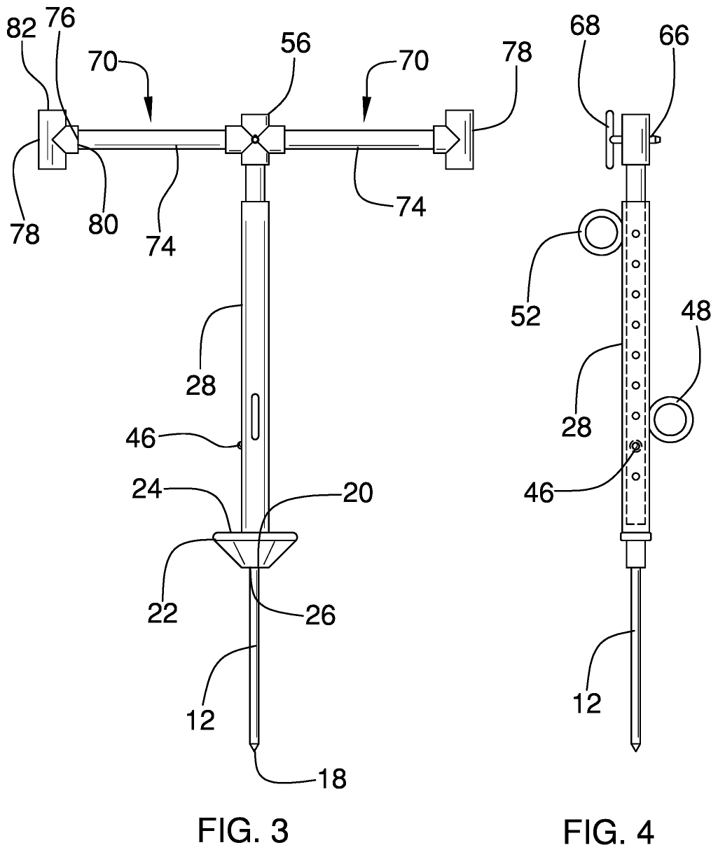

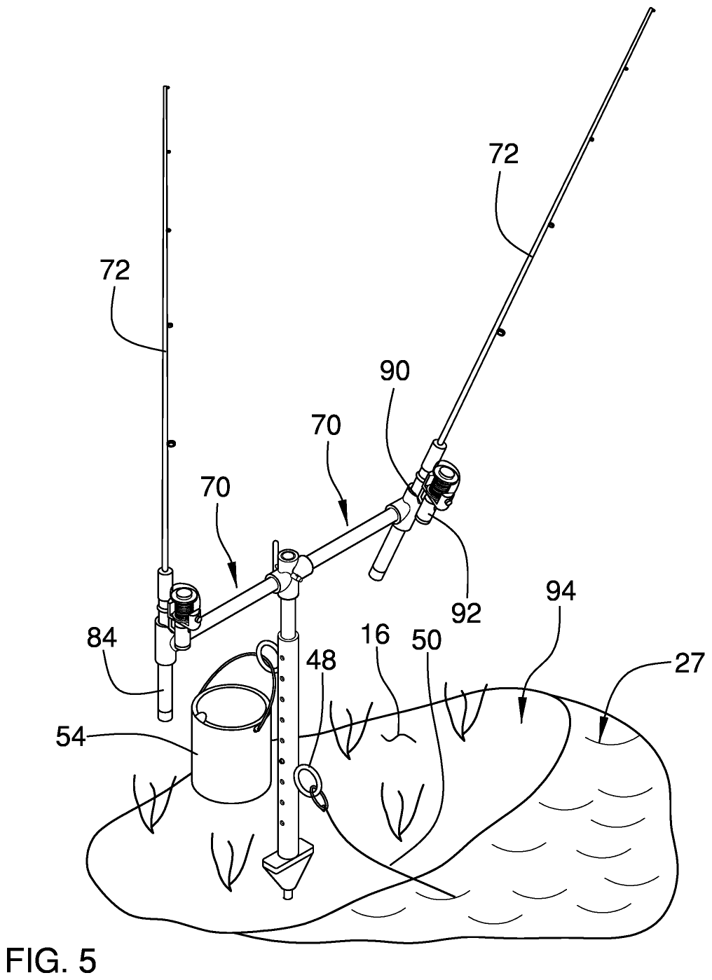

With reference now to the drawings, and in particular to FIGS. 1 through 5 thereof, a new rod holder device embodying the principles and concepts of an embodiment of the disclosure and generally designated by the reference numeral 10 will be described.

As best illustrated in FIGS. 1 through 5, the fishing rod holder assembly 10 generally comprises a spike 12 that has a striking surface 14 extending laterally away from the spike 12. In this way the striking surface 14 can be struck with an object, such as a hammer or other similar tool, to drive the spike 12 into a support surface 16. The spike 12 has a lower end 18 and an upper end 20, and the lower end 18 tapers to a point. A wedge 22 is included that has a top surface 24 and a bottom end 26, and the spike 12 extends through the top surface 24 and the bottom end 26. In this way the top surface 24 defines the striking surface 14. The support surface 16 may be the ground at a beach of a body of water 27, such as a river or like, in which a fisherman intends to fish.

A pole 28 is included which has a first portion 30 that slidably receives a second portion 32 such that the pole 28 has a telescopically adjustable length. The pole 28 extends upwardly from the spike 12 such that the pole 28 is vertically oriented when the spike 12 is driven into the support surface 16. The pole 28 has a first end 34 and a second end 36; the first end 34 is associated with the first portion 30 and the second end 36 is associated with the second portion 32. The first portion 30 has an outer wall 38 and the outer wall 38 has a plurality of apertures 40 each extends through the outer wall 38. The apertures 40 are spaced apart from each other and are distributed along a full length of the first portion 30. The second portion 32 has an outside wall 42, the outside wall 42 has a pin hole 44 extending through the outside wall 42 and the pin hole 44 is positioned adjacent to the second end 36.

A lock 46 is movably integrated into the second portion 32 of the pole 28. The lock 46 is biased to engage a respective one of the apertures 40 in the first portion 30 for retaining the pole 28 at a selected length. The lock 46 is biased outwardly from the second portion 32 and the lock 46 is urgeable inwardly on the second portion 32 to disengage the lock 46 from the respective aperture. The lock 46 may comprise a ball that is biased outwardly from the second portion 32 of the pole 28 or other type of spring loaded mechanism.

A first ring 48 is coupled to the pole 28 and a fish stringer 50 can be attached to the first ring 48. The first ring 48 is positioned on the outer wall 38 of the first portion 30 and the first ring 48 lies on a plane that extends between the upper end 20 and the lower end 18 of the pole 28. Additionally, the first ring 48 is positioned closer to the first end 34 than the second portion 32. A second ring 52 is coupled to the pole 28 and a bait bucket 54 can be coupled to the second ring 52. The second ring 52 is positioned on the second portion 32 of the pole 28 and the second ring 52 lies on the plane extending between the upper end 20 and the lower end 18 of the pole 28. The second ring 52 is positioned closer to the second portion 32 than the first end 34 of the lower portion. Additionally, the second ring 52 is positioned on an opposite side of the second portion 32 with respect to the first ring 48.

A four way tee 56 is removably attachable to the pole 28 and the four way tee 56 has a plurality of openings 58 that is each distributed around a center point 60 of the four way tee 56. A respective pair of openings 58 that is oriented on an axis which is oriented perpendicular to an axis associated with a respective pair of the openings 58. The four way tee 56 has a hole 62 extending through a body 64 of the four way tee 56 and the hole 62 is aligned with the center point 60 of the four way tee 56. A respective one of the openings 58 insertably receives the second end 36 of the pole 28. The hole 62 is aligned with the pin hole 44 in the second portion 32 of the pole 28 when the second end 36 is inserted into the respective opening 58. A pin 66 is extendable through the hole 62 in the four way tee 56 and the pin hole 44 in the second portion 32 of the pole 28 for retaining the four way tee 56 on the pole 28. The pin 66 might include a handle 68 that is oriented transverse with the pin 66 for gripping.

A pair of rod holders 70 is each attachable to the four way tee 56 when the four way tee 56 is coupled to the pole 28, and each of the rod holders 70 can hold a fishing rod 72. Each of the rod holders 70 comprises a pipe 74 that is inserted into a respective one of the openings 58 in the four way tee 56. Thus, the pipe 74 is oriented to extend along a line which is oriented perpendicular to the axis extending through the first end 34 and the second end 36 of the pole 28. Additionally, the pipe 74 has a distal end 76 with respect to the four way tee 56.

Each of the rod holders 70 includes a holder 78 that has a first opening 80 lying on a plane that is oriented perpendicular to a second opening 82. The first opening 80 insertably receives the distal end 76 of the pipe 74 such that the second opening 82 is directed upwardly. In this way the second opening 82 can insertably receive a handle 84 of the fishing rod 72. The second opening 82 has a bounding edge 86 and the bounding edge 86 has a recess 88 that is integrated into the bounding edge 86. The recess 88 accommodates a support bracket 90 of a reel 92 on the fishing rod 72 thereby inhibiting the fishing rod 72 from rotating in the holder 78.

In use, the spike 12 is driven into the support surface 16 at a location next to the shoreline 94 of the body of water 27 such that the first ring 48 faces the body of water 27 and the second ring 52 faces the shoreline 84. In way the fish stringer 50 can be attached to the first ring 48 while allowing the first stringer 50 to be positioned in the body of water 27. The four way tee 56 is positioned on the pole 28 and the pin 66 is extended through the four way tee 56 and the pole 28 to secure the four way tee 56 to the pole 28. The handle of the fishing rod 72 is inserted into the holder 78 of a respective rod holder 78. In this way a pair of fishing rods 72 can be held in an upright manner during fishing.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing rod holder assembly for holding multiple fishing rods, said assembly comprising:
a spike having a striking surface extending laterally away from said spike wherein said striking surface is configured to be struck with an object to drive said spike into a support surface;
a pole having a first portion slidably receiving a second portion such that said pole has a telescopically adjustable length, said pole extending upwardly from said spike such that said pole is vertically oriented when said spike is driven into the support surface;
a first ring being coupled to said pole wherein said first ring is configured to have a fish stringer attached thereto;
a second ring being coupled to said pole wherein said second ring is configured to have a bait bucket coupled thereto;
a four way tee being removably attachable to said pole, said four way tee having a plurality of openings each being distributed around a center point of said four way tee, a respective one of said openings insertably receiving said pole; and
a pair of rod holders, each of said rod holders being attachable to said four way tee when said four way tee is coupled to said pole wherein each of said rod holders is configured to hold a fishing rod.

2. The assembly according to claim 1, wherein:
said spike has a lower end and an upper end, said lower end tapering to a point; and
said assembly includes a wedge having a top surface and a bottom end, said spike extending through said top surface and said bottom end such that said top surface defines said striking surface, said top surface being aligned with said upper end of said spike.

3. The assembly according to claim 2, wherein said pole has a first end and a second end, said first end being associated with said first portion, said second end being associated with said second portion, said first portion having an outer wall, said outer wall having a plurality of apertures each extending through said outer wall, said apertures being spaced apart from each other and being distributed along a full length of said first portion, said second portion having an outside wall, said outside wall having a pin hole extending through said outside wall, said pin hole being positioned adjacent to said second end.

4. The assembly according to claim 3, further comprising a lock being movably integrated into said second portion of said pole, said lock engaging a respective one of said apertures in said first portion for retaining said pole at a selected length, said lock being biased outwardly from said second portion, said lock being urgeable inwardly on said second portion to disengage said lock from said respective aperture.

5. The assembly according to claim 3, wherein:
said first ring is positioned on said outer wall of said first portion, said first ring lying on a plane extending between said upper end and said lower end of said pole, said first ring being positioned closer to said first end than said second portion; and
said second ring is positioned on said second portion of said pole, said second ring lying on said plane extending between said upper end and said lower end of said pole, said second ring being positioned closer to said second portion than said first end of said lower portion, said second ring being positioned on an opposite side of said lower portion with respect to said first ring.

6. The assembly according to claim 2, wherein:
a respective pair of said openings in said four way tee being oriented on an axis being oriented perpendicular to an axis associated with a respective pair of said openings, said four way tee having a hole extending through a body of said four way tee, said hole being aligned with said center point of said four way tee, a respective one of said openings insertably receiving said second end of said pole, said hole being aligned with said pin hole in said second portion of said pole when said second end is inserted into said respective opening; and
said assembly includes a pin being extendable through said hole in said four way tee and said pin hole in said second portion of said pole for retaining said four way tee on said pole.

7. The assembly according to claim 2, wherein each of said rod holders comprises:
a pipe being inserted into a respective one of said openings in said four way tee such that said pipe is oriented to extend along a line being oriented perpendicular to said axis extending through said first end and said second end of said pole, said pipe having a distal end with respect to said four way tee; and
a holder having a first opening lying on a plane being oriented perpendicular to a second opening, said first opening insertably receiving said distal end of said pipe such that said second opening is directed upwardly wherein said second opening is configured to insertably receive a handle of the fishing rod, said second opening having a bounding edge, said bounding edge having a recess being integrated into said bounding edge wherein said recess is configured to accommodate a support bracket of a reel on the fishing rod thereby inhibiting the fishing rod from rotating in said holder.

8. A fishing rod holder assembly for holding multiple fishing rods, said assembly comprising:
a spike having a striking surface extending laterally away from said spike wherein said striking surface is configured to be struck with an object to drive said spike into a support surface, said spike having a lower end and an upper end, said lower end tapering to a point;
a wedge having a top surface and a bottom end, said spike extending through said top surface and said bottom end such that said top surface defines said striking surface, said top surface being aligned with said upper end of said spike;
a pole having a first portion slidably receiving a second portion such that said pole has a telescopically adjustable length, said pole extending upwardly from said spike such that said pole is vertically oriented when said spike is driven into the support surface, said pole having a first end and a second end, said first end being associated with said first portion, said second end being associated with said second portion, said first portion having an outer wall, said outer wall having a plurality of apertures each extending through said outer wall, said apertures being spaced apart from each other and being distributed along a full length of said first portion, said second portion having an outside wall, said outside wall having a pin hole extending through said outside wall, said pin hole being positioned adjacent to said second end;
a lock being movably integrated into said second portion of said pole, said lock engaging a respective one of said apertures in said first portion for retaining said pole at a selected length, said lock being biased outwardly from said second portion, said lock being urgeable inwardly on said second portion to disengage said lock from said respective aperture;
a first ring being coupled to said pole wherein said first ring is configured to have a fish stringer attached thereto, said first ring being positioned on said outer wall of said first portion, said first ring lying on a plane extending between said upper end and said lower end of said pole, said first ring being positioned closer to said first end than said second portion;
a second ring being coupled to said pole wherein said second ring is configured to have a bait bucket coupled thereto, said second ring being positioned on said second portion of said pole, said second ring lying on said plane extending between said upper end and said lower end of said pole, said second ring being positioned closer to said second portion than said first end of said lower portion, said second ring being positioned on an opposite side of said lower portion with respect to said first ring;
a four way tee being removably attachable to said pole, said four way tee having a plurality of openings each being distributed around a center point of said four way tee, a respective pair of openings being oriented on an axis being oriented perpendicular to an axis associated with a respective pair of said openings, said four way tee having a hole extending through a body of said four way tee, said hole being aligned with said center point of said four way tee, a respective one of said openings insertably receiving said second end of said pole, said hole being aligned with said pin hole in said second portion of said pole when said second end is inserted into said respective opening;
a pin being extendable through said hole in said four way tee and said pin hole in said second portion of said pole for retaining said four way tee on said pole; and
a pair of rod holders, each of said rod holders being attachable to said four way tee when said four way tee is coupled to said pole wherein each of said rod holders is configured to hold a fishing rod, each of said rod holders comprising:
a pipe being inserted into a respective one of said openings in said four way tee such that said pipe is oriented to extend along a line being oriented perpendicular to said axis extending through said first end and said second end of said pole, said pipe having a distal end with respect to said four way tee; and
a holder having a first opening lying on a plane being oriented perpendicular to a second opening, said first opening insertably receiving said distal end of said pipe such that said second opening is directed upwardly wherein said second opening is configured to insertably receive a handle of the fishing rod, said second opening having a bounding edge, said bounding edge having a recess being integrated into said bounding edge wherein said recess is configured to accommodate a support bracket of a reel on the fishing rod thereby inhibiting the fishing rod from rotating in said holder.
